(19) United States
(12) Patent Application Publication
(10) Pub. No.: US 2005/0268506 A1
(43) Pub. Date: Dec. 8, 2005

(54) Online boxing scrapbook

(76) Inventor: John W. Black, Las Vegas, NV (US)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 11/143,138

(22) Filed: Jun. 2, 2005

Related U.S. Application Data
(60) Provisional application No. 60/576,207, filed on Jun. 2, 2004.

(51) Int. Cl. G09F 21/02

(52) U.S. Cl. 40/586

(57) ABSTRACT

An online boxing scrapbook tailored and personalized to the needs of the boxer, trainer, manager, promoter, sports writer, publicist, venue, boxing executive, or fan. The present invention essentially provides a boxing digest that is customized to particular individuals based on their interests, and that filters out information unwanted by these individuals. The boxing digest gathers information from numerous sources, online or otherwise. In selected embodiments, each subscriber to the scrapbook receives an email alert any time new information becomes available regarding a particular boxer or topic of interest.

### RELATED APPLICATIONS

This application claims priority to U.S. Provisional Patent Application Ser. No. 60/576,207 filed Jun. 2, 2004, entitled ONLINE BOXING SCRAPBOOK.

### BACKGROUND OF THE INVENTION

1. Field of the Invention

The present invention relates to apparatus and methods for providing online boxing information. In particular, the present invention relates to systems and methods for providing an integrated source of online boxing information to boxers, trainers, promoters, sports writers, publicists, venues, boxing executives, and fans.

2. Background and Related Art

To the fan, as well as to the boxer, trainer, promoter, sports writer, publicist, venue, and boxing executive, the process of gathering boxing information can be very time-consuming. Due to the overwhelming amount of boxing information that is available, one can spend hours everyday reading articles in any of numerous boxing websites or news sources and still miss critical news about certain boxers, weight classes, topics, or members of the boxing community. Thus, apparatus and methods are needed to integrate the large quantity of information that is available into a single reliable source.

### SUMMARY OF THE INVENTION

The present invention relates to apparatus and methods for compiling boxing information, gathered from numerous sources, into a single reliable source. The present invention further relates to apparatus and methods for tailoring and personalizing boxing information services to the needs and desires of specific groups or individuals.

Consistent with the foregoing, and in accordance with the invention as embodied and broadly described herein, apparatus and methods in accordance with the present invention provide an online scrapbook tailored and personalized to the needs of the boxer, trainer, manager, promoter, sports writer, publicist, venue, boxing executive, or fan. The present invention essentially provides a boxing digest customized to individuals based on their personal interests and filters out unwanted information. The online boxing scrapbook gathers and compiles information from various sources, online or otherwise. In selected embodiments, each subscriber to the scrapbook receives information alerts or notification whenever information of interest becomes available.

### DETAILED DESCRIPTION OF THE INVENTION

It will be readily understood that the concepts and components of the present invention, as generally described herein, could be arranged and designed in a wide variety of different configurations. Thus, the following more detailed description of the embodiments of the system and method of the present invention, as represented herein, is not intended to limit the scope of the invention, as claimed, but it is merely representative of certain embodiments of the invention. Thus, the following description is intended only as an example, and simply illustrates one present embodiment consistent with the invention as claimed herein.

In the disclosure and in the claims the term “boxing” shall refer to any sport that would benefit from an apparatus and method such as herein disclosed, such as basketball, football, baseball and tennis.

The present invention relates to an online boxing scrapbook that can be personalized to individual boxers, trainers, managers, promoters, sports writers, publicists, venues, boxing executives, fans, or the like. For example, the online boxing scrapbook includes various features such as content gathering, organizing, filtering, archiving, presenting, searching, and alert systems. The online boxing scrapbook can also be configured to gather boxing information by compiling articles and content from various sources of boxing information including but not limited to boxing websites, sports websites, or other sporting or boxing news sources. In selected embodiments, the online boxing scrapbook can be configured to compile and gather boxing content similar to conventional web crawlers or spiders that scour the Internet in search of desired content. Boxing content includes written articles, images, sound, video, or other text or multimedia content. The online boxing scrapbook takes this content and organizes it to make it easily perusable by a reader thereof. For example, content can be organized according to boxers' names, weight classes, ages, topics, nationalities, rankings, records, titles held, boxing governing bodies (i.e. IBO, IBF, WBO, etc.), or the like. In selected embodiments, the online boxing scrapbook highlights, bolds, formats or colors selected information to make it stand out from other types of information.

The online boxing scrapbook also provides content filtering according to an individual's interests. For example, many fans have a favorite weight class. In addition, Latinos are often primarily interested in Latino fighters and Germans may be mostly interested in German fighters. The online boxing scrapbook allows the fan to set certain criteria, preferences, or filters so the fan only receives information he or she wants, whether it be information regarding a preferred boxer, weight class, topic, nationality, ranking, record, title held, boxing governing body, or the like. Thus, the online boxing scrapbook personalizes or tailors information to certain groups or individuals. Sportswriters can cut and paste content from the online boxing scrapbook when researching boxing information. Local sportswriters can set criteria such that primarily local boxing information is added to his/her scrapbook. Promoters and publicists can use the online boxing scrapbook as an effective publicity tool. In selected embodiments, the online boxing scrapbook can be personalized to each member or subscriber when that person logs onto or accesses the online boxing scrapbook.

The online boxing scrapbook can also archive content, including articles, images, sound clips, video clips, or the like, for later retrieval. The online boxing scrapbook searches current content as well as archived content. In certain embodiments, searches are performed according to content type (i.e. articles, video clips, images, etc.) or selected criteria (i.e. boxer's name, weight class, ranking, etc.).

The online boxing scrapbook also provides various alerts or notification services, such as email alerts, to notify an individual when news or content of interest has been posted regarding a particular boxer, weight class, topic, or the like. The online boxing scrapbook also provides a historical record of a particular boxer, fan, or the like. The individual can repeatedly revisit his/her scrapbook as desired. Thus, the online boxing scrapbook is a keepsake or memento to certain individuals.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. An online boxing service comprising:
a content gathering module for gathering boxing information from at least one boxing information source;
a content sorting module for organizing the boxing information according to selected criteria; and
a content filtering module for filtering the boxing information according to at least one preference selected by an individual.

2. The online boxing service of claim 1, further comprising a content archiving module for archiving the boxing information.

3. The online boxing service of claim 1, further comprising a content presentation module for performing at least one task selected from the group comprising highlighting, bolding, formatting and coloring selected components of the boxing information.

4. The online boxing service of claim 1, further comprising a content searching module for searching at least one of current and archived boxing information.

5. The online boxing service of claim 1, further comprising an alert system for notifying a user of the online boxing service that certain boxing information is available.

6. The online boxing service of claim 1, wherein the boxing information is selected from the group comprising articles, video clips, sound clips, and images.

7. The online boxing service of claim 1, wherein the preference is selected from the group comprising a boxer's name, weight class, age, topic, nationality, ranking, record, title held, and a boxing governing body.

8. A method for gathering, organizing and filtering boxing information comprising:
providing a computer readable medium;
gathering boxing information from at least one boxing information source;
organizing the boxing information according to selected criteria; and
filtering the boxing information according to at least one preference selected by an individual.

9. A computer program product for implementing within a computer system a method for gathering, organizing and filtering boxing information comprising:
a computer readable medium for providing computer program code means utilized to implement the method, wherein the computer program code means is comprised of executable code for implementing the steps of:
gathering boxing information from at least one boxing information source;
organizing the boxing information according to selected criteria; and
filtering the boxing information according to at least one preference selected by an individual.

10. A system containing a computer program product, the product comprising:
a computer readable medium for providing computer program code means utilized to implement the method, wherein the computer program code means is comprised of executable code for implementing the steps of:
gathering boxing information from at least one boxing information source;
organizing the boxing information according to selected criteria; and
filtering the boxing information according to at least one preference selected by an individual.
